(19) United States
(12) Patent Application Publication
(10) Pub. No.: US 2025/0062558 A1
(43) Pub. Date: Feb. 20, 2025

(54) CONNECTOR AND ELECTRONIC DEVICE

(71) Applicant: KYOCERA CORPORATION, Kyoto (JP)

(72) Inventor: Yousuke MANBA, Yokohama-shi, Kanagawa (JP)

(21) Appl. No.: 18/726,108

(22) PCT Filed: Jan. 4, 2023
(86) PCT No.: PCT/JP2023/000023

§ 371 Date: Jul. 1, 2024

(30) Foreign Application Priority Data
Jan. 6, 2022 (JP) 2022-001281

(51) Int. Cl. H01R 12/77; H01R 12/79

(52) U.S. Cl. CPC H01R 12/774; H01R 12/79

(57) ABSTRACT

A connector according to the present disclosure includes an insulator including an insertion portion into which a connection object is to be inserted and an actuator rotatable relative to the insulator. The actuator includes two mounting portions, an operating portion, and a mated portion. The two mounting portions are respectively located on opposite ends of the actuator in a longitudinal direction of the connector and allow the actuator to be mounted on the insulator. The operating portion is located between the two mounting portions on a first outer surface of the actuator. The mated portion is located between the two mounting portions on a second outer surface of the actuator that is opposite the first outer surface. The insulator includes a mating portion to mate, from an open-position side, with the mated portion at least when the actuator is in the open position.

### CROSS-REFERENCE TO RELATED APPLICATIONS

The present application claims priority to Japanese Patent Application No. 2022-001281, filed on Jan. 6, 2022, which is hereby incorporated by reference herein in its entirety.

### TECHNICAL FIELD

The present disclosure relates to a connector and an electronic device.

### BACKGROUND OF INVENTION

For example, known electronic devices and on-vehicle components use connection objects including an FFC (flexible flat cable) and an FPC (flexible printed circuit board) and connectors connected to such connection objects.

For example, Patent Literature 1 discloses a cable connector that can effectively reduce a likelihood that a connection object may be unintentionally removed from an insulator even when a locking member for maintaining a connected state of the connection object is rotated and urged in a locking direction with a small urging force. Such a cable connector can ensure a locked state achieved by the locking member with only one action of inserting the connection object into the insulator, and provides excellent ease of operation.

### CITATION LIST

### Patent Literature

Patent Literature 1: Japanese Patent No. 6282565

### SUMMARY

In an embodiment of the present disclosure, a connector into and from which a connection object is insertable and removable includes an insulator and an actuator. The insulator includes an insertion portion into which a connection object is to be inserted. The actuator is rotatable relative to the insulator between a closed position in which the actuator is closed relative to the insulator and an open position in which the actuator is opened relative to the insulator. The actuator includes two mounting portions, an operating portion, and a mated portion. The two mounting portions are respectively located on opposite ends of the actuator in a longitudinal direction of the connector and allow the actuator to be mounted on the insulator. The operating portion is located between the two mounting portions on a first outer surface of the actuator that faces in an insertion and removal direction of the connection object relative to the connector and is configured to be operated to open the actuator from the closed position to the open position. The mated portion is located between the two mounting portions on a second outer surface of the actuator that is opposite the first outer surface. The insulator includes a mating portion to mate, from an open-position side, with the mated portion at least when the actuator is in the open position.

In an embodiment of the present disclosure, an electronic device includes the above-described connector.

### BRIEF DESCRIPTION OF THE DRAWINGS

FIG. 1 is a downward perspective view of a connector according to an embodiment and a connection object in a non-insertion state.

FIG. 2 is an upward perspective view of the connector and the connection object in FIG. 1.

FIG. 3 is an exploded perspective view of the connector in FIG. 1.

FIG. 4 is a downward perspective view of the connector according to an embodiment with the connection object in a fully inserted state and a closed state.

FIG. 5 is a downward perspective view of the connector according to an embodiment with the connection object in the fully inserted state and an open state.

FIG. 6 is a top view of an insulator alone in FIG. 3.

FIG. 7 is an upward perspective view of an actuator alone in FIG. 3.

FIG. 8 is a cross-sectional view taken along arrow line VIII-VIII in FIG. 1.

FIG. 9 is a cross-sectional view taken along arrow line IX-IX in FIG. 4.

FIG. 10 is a cross-sectional view taken along arrow line X-X in FIG. 5.

FIG. 11 is a cross-sectional view taken along arrow line XI-XI in FIG. 1.

FIG. 12 is a cross-sectional view taken along arrow line XII-XII in FIG. 4.

FIG. 13 is a cross-sectional view taken along arrow line XIII-XIII in FIG. 5.

FIG. 14 is a cross-sectional view taken along arrow line XIV-XIV in FIG. 1.

FIG. 15 is a cross-sectional view taken along arrow line XV-XV in FIG. 4.

FIG. 16 is a cross-sectional view taken along arrow line XVI-XVI in FIG. 5.

FIG. 17 is a cross-sectional view taken along arrow line XVII-XVII in FIG. 1.

FIG. 18 is a cross-sectional view taken along arrow line XVIII-XVIII in FIG. 4.

FIG. 19 is a cross-sectional view taken along arrow line XIX-XIX in FIG. 5.

### DESCRIPTION OF EMBODIMENTS

For example, as electronic devices and on-vehicle components have recently been miniaturized, connectors to be connected to connection objects are also required to have a lower profile. Reducing a profile of a cable connector like, for example, that disclosed in Patent Literature 1, requires a reduction in thickness of an actuator as a locking member constituting a part of the connector. A reduction in thickness of the actuator causes the actuator to tend to bend at an operating portion of the actuator in an opening direction when a connection object is unlocked by opening the actuator from a closed position to an open position. Such bending is likely to cause issues, such as a reduction in stability of rotation of the actuator, breakage of the actuator, and separation of the actuator from the connector. This results in lower reliability of the connector. Such issues have not been considered sufficiently in Patent Literature 1.

A connector and an electronic device according to an embodiment of the present disclosure can maintain reliability even when reduced in profile.

An embodiment of the present disclosure will be described in detail below with reference to the accompanying drawings. In the following description, front-rear, left-right, and up-down directions are based on directions of arrows in the figures. The directions of the arrows in different figures agree with each other. For simplification of illustration, a circuit board CB, which will be described later, is not illustrated in some of the figures.

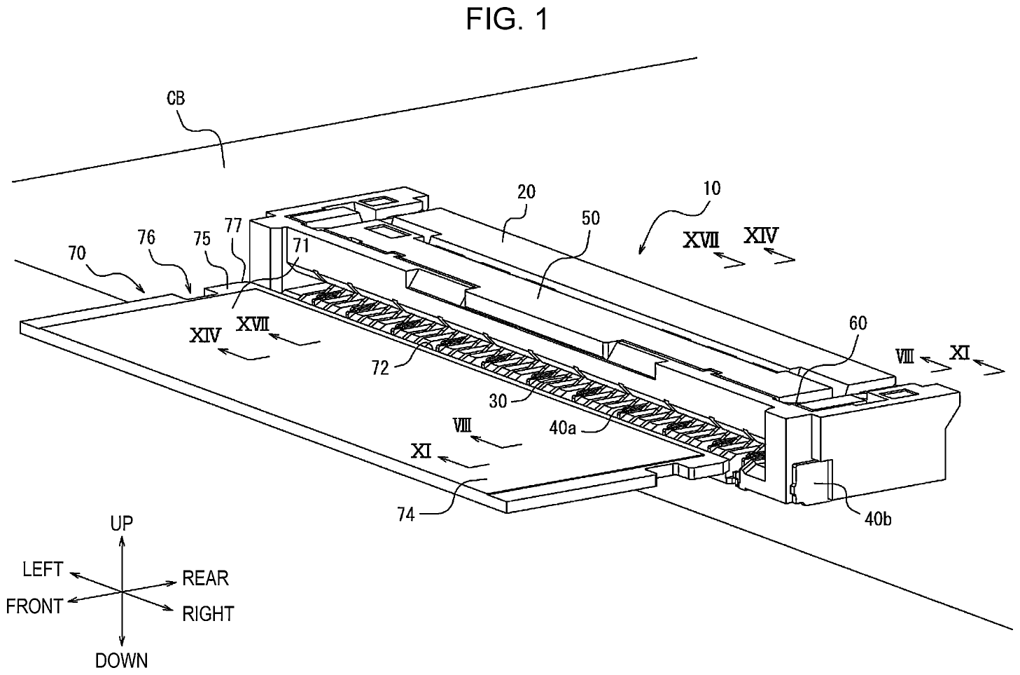

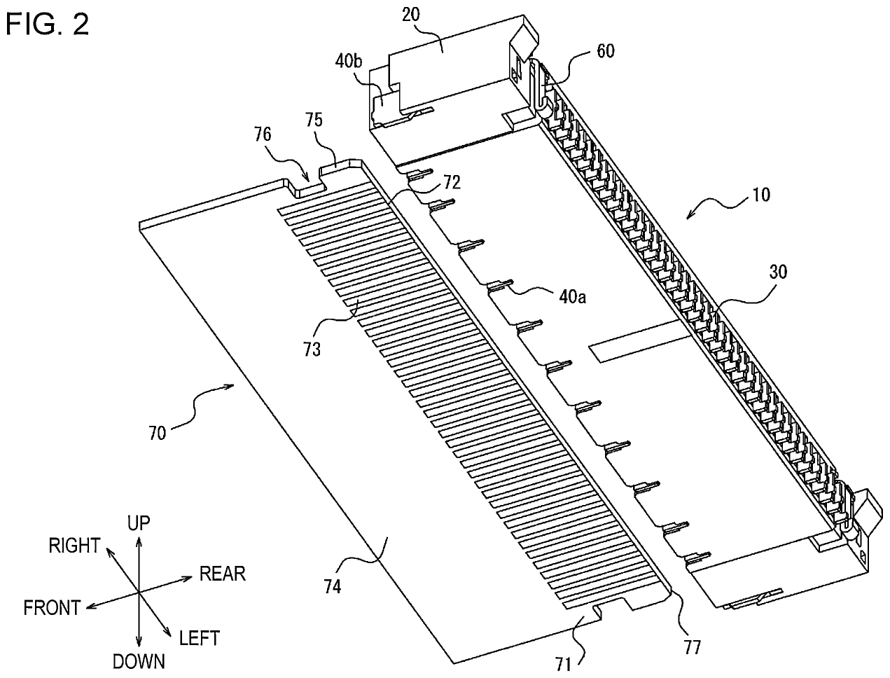

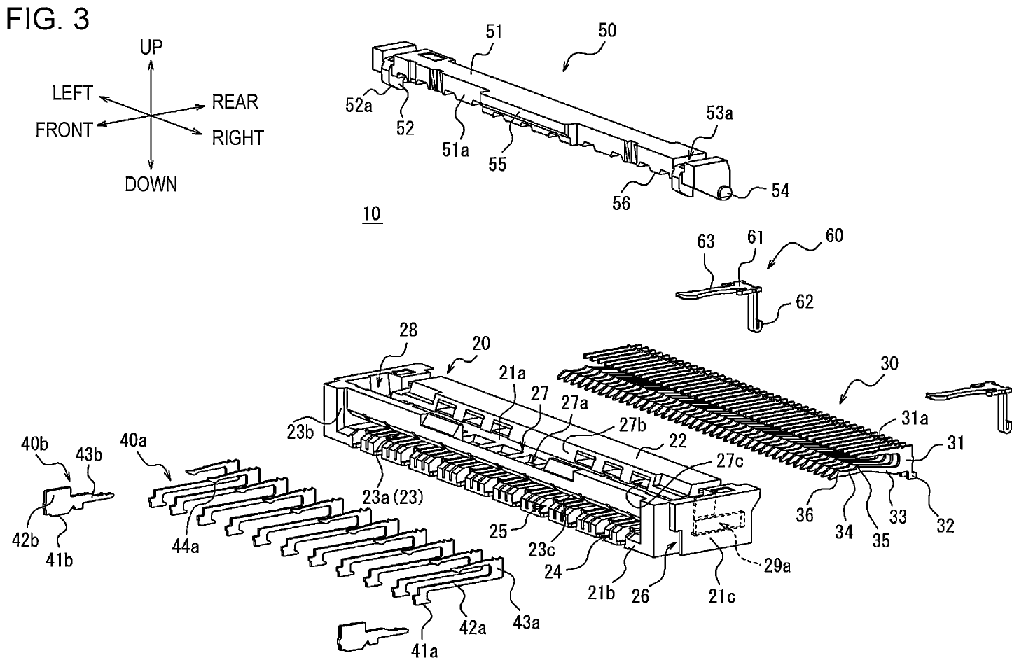

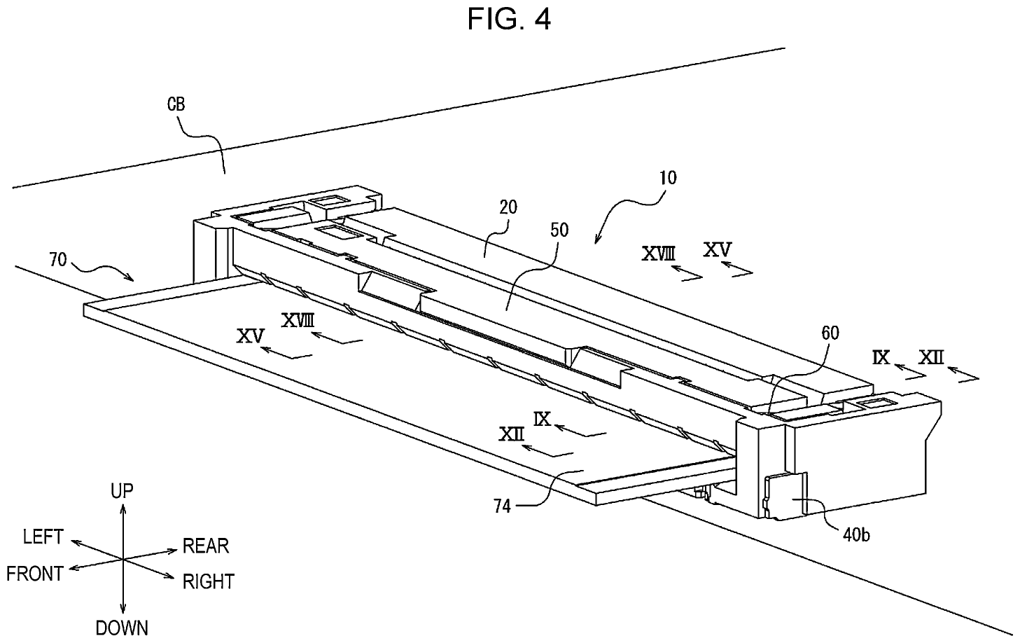

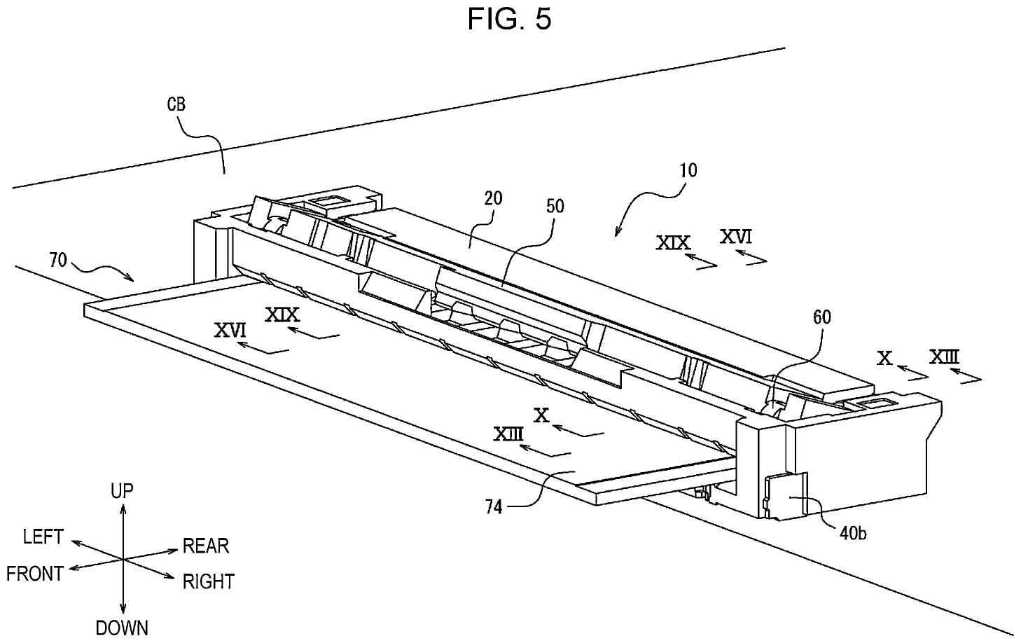

FIG. 1 is a downward perspective view of a connector 10 according to an embodiment and a connection object 70 in a non-insertion state. FIG. 2 is an upward perspective view of the connector 10 and the connection object 70 in FIG. 1. FIG. 3 is an exploded perspective view of the connector 10 in FIG. 1. FIG. 4 is a downward perspective view of the connector 10 according to an embodiment with the connection object 70 in a fully inserted state and a closed state. FIG. 5 is a downward perspective view of the connector 10 according to an embodiment with the connection object 70 in the fully inserted state and an open state. The configuration of the connector 10 according to an embodiment and the configuration of the connection object 70 will be mainly described with reference to FIGS. 1 to 5.

As illustrated in FIG. 3, the connector 10 includes an insulator 20, a first contact 30, a second contact 40a, a fitting 40b, an actuator 50, and a pressing member 60. The first contact 30, the second contact 40a, the fitting 40b, the actuator 50, and the pressing member 60 are mounted in and on the insulator 20. The actuator 50 in a closed position is supported from below by the insulator 20 while a tip portion of the pressing member 60 is located directly on the actuator 50.

As used herein, the “non-insertion state” refers to, for example, a state where the connection object 70 is not inserted into the connector 10. The non-insertion state includes a state where the first contact 30 of the connector 10 is not elastically deformed. A “partially inserted state” refers to, for example, a state where the connection object 70 is inserted into the connector 10. The partially inserted state includes a state where only a removing portion 36, which will be described later, of the first contact 30 is in contact with the connection object 70 and where the first contact 30 is elastically deformed. The “fully inserted state” refers to, for example, a state where the connection object 70 is held in the connector 10. The fully inserted state includes a state where only a contact portion 35, which will be described later, of the first contact 30 is in contact with the connection object 70 and where the first contact 30 is elastically deformed.

As used herein, the “closed position” includes a position of the actuator 50 closed relative to the insulator 20. The connector 10 holds the connection object 70 while the connector 10 and the connection object 70 are in the fully inserted state and the actuator 50 is in the closed position. An “open position” includes a position of the actuator 50 opened at a predetermined angle to the insulator 20. The actuator 50 is rotatable relative to the insulator 20 between, for example, the closed position and the open position.

As used herein, the “closed state” includes a state of the connector 10 with the actuator 50 in the closed position. The “open state” includes a state of the connector 10 with the actuator 50 in the open position.

As used herein, an “insertion/removal direction” refers to, for example, the front-rear direction. An “insertion direction” refers to, for example, a rearward direction. A “direction in which the contact portion 35 protrudes” refers to, for example, an upward direction. A “direction opposite to the direction in which the contact portion 35 protrudes” refers to, for example, a downward direction. A “direction orthogonal to the direction in which the contact portion 35 protrudes and orthogonal to the insertion direction” refers to, for example, the left-right direction. In the connector 10 according to an embodiment, the direction orthogonal to the direction in which the contact portion 35 protrudes and orthogonal to the insertion direction corresponds to a thickness direction of the first contact 30. A “longitudinal direction of the connector 10” refers to, for example, the left-right direction. A “direction orthogonal to the longitudinal direction of the connector 10 and orthogonal to the insertion/removal direction” refers to, for example, the up-down direction. A “removal side” refers to, for example, a front side. An “insertion side” refers to, for example, a rear side. An “insertion-opening-23a side” refers to, for example, the front side. An “open position side” refers to, for example, an upper side, and is synonymous with “open-position side” described in Claims. A “closed position side” refers to, for example, a lower side.

In an embodiment, the connector 10 is installed on the circuit board CB. The circuit board CB may be a rigid board or may be any other circuit board. The connector 10 causes the connection object 70 held in the connector 10 to be electrically connected to the circuit board CB via the first contact 30 and the second contact 40a. The connector 10, into and from which the connection object 70 is insertable and removable, is connected to the connection object 70 in the fully inserted state.

In the following description, it is assumed that the connection object 70 is inserted into the connector 10 in a direction parallel to the circuit board CB, on which the connector 10 is installed. The connection object 70 is inserted into the connector 10 in, for example, the front-rear direction. The connection object 70 may be inserted into the connector 10 in any other direction. The connection object 70 may be inserted into the connector 10 in a direction orthogonal to the circuit board CB, on which the connector 10 is installed. The connection object 70 may be inserted into the connector 10 in the up-down direction.

The connection object 70 is, for example, an FFC (flexible flat cable). The connection object 70 is, however, not limited to this example. The connection object 70 may be any cable to be electrically connected to the circuit board CB with the connector 10. For example, the connection object 70 may be an FPC (flexible printed circuit board). The connection object 70 is not limited to the above-described cable, and may include any object. For example, the connection object 70 may include a rigid board or any other circuit board.

Referring to FIGS. 1 and 2, the connection object 70 includes an end portion 71. The end portion 71 is located on the insertion side of the connection object 70 and is to be held by the connector 10 in the fully inserted state. The end portion 71 of the connection object 70 includes an end face 72 defining an edge of the connection object 70 that is located on the insertion side. The connection object 70 includes multiple signal lines 73 extending straight in the insertion/removal direction relative to the connector 10 and extending up to the end face 72. The connection object 70 includes an outer cover 74 covering the signal lines 73 on the removal side of the connection object 70. The signal lines 73 are covered by the outer cover 74 on the removal side of the connection object 70 and are exposed on a lower surface of the end portion 71.

The connection object 70 includes retainers 75 that are located on right and left or opposite sides of the end portion 71 on the insertion side. The connection object 70 includes lock recesses 76 that are next to the retainers 75 and are located on the removal side relative to the retainers 75. The lock recesses 76 are formed by cutting away parts of the right and left or opposite sides of the end portion 71. The connection object 70 includes guides 77. Each of the guides 77 is rounded and is located at a corner of the retainer 75 that is located on the insertion side.

With reference to FIG. 3, the connector 10 is assembled in the following manner, for example. The first contact 30 is pressed into the rear of the insulator 20. The second contact 40a and the fitting 40b are pressed into the front of the insulator 20. The actuator 50 is placed from above to the closed position relative to the insulator 20. While the actuator 50 is supported from below by the insulator 20, the pressing member 60 is pressed into the rear of the insulator 20. At this time, the tip portion of the pressing member 60 is located directly on the actuator 50 supported by the insulator 20.

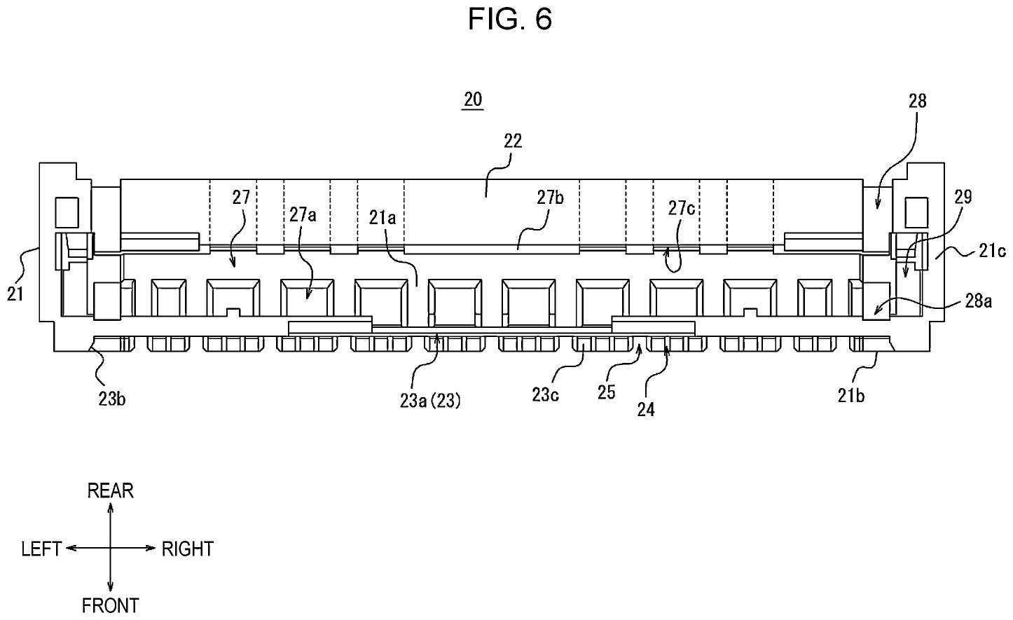

FIG. 6 is a top view of the insulator 20 alone in FIG. 3. The configuration of the insulator 20 will be mainly described with reference to FIGS. 3 and 6.

The insulator 20 is a bilaterally symmetrical box-shaped member made of an insulating heat-resistant synthetic resin material formed by injection molding. The shape of the insulator 20 is not limited to this example. The insulator 20 may have a bilaterally asymmetrical shape. The insulator 20 includes an outer peripheral wall 21. The outer peripheral wall 21 includes upper, lower, left, and right outer walls, or four outer walls. The outer peripheral wall 21 is rectangular in overall shape. The outer peripheral wall 21 includes a top wall 21a, a bottom wall 21b, and two side walls 21c. The insulator 20 includes a rear wall 22 defining the rear of the insulator 20.

The insulator 20 includes an insertion portion 23 surrounded by the top wall 21a, the bottom wall 21b, the two side walls 21c, and the rear wall 22. The insulator 20 includes an insertion opening 23a of the insertion portion 23. The insertion opening 23a is an opening located at a front end of the insulator 20. The insulator 20 includes a first angled face 23b located at a front end of each of the two side walls 21c. The first angled face 23b is angled inward in the left-right direction and extends inward in the front-rear direction to the insertion portion 23. The insulator 20 includes second angled faces 23c located at a front end of the insertion portion 23. Each of the second angled faces 23c slopes inward in the up-down direction and inward in the front-rear direction. As illustrated in, for example, FIG. 17, which will be described later, the insertion portion 23 includes an inner face 23d that serves as a reference to position the end face 72 of the connection object 70 in the insertion direction in the fully inserted state.

The insulator 20 includes a first-contact mounting groove 24. The first-contact mounting groove 24 extends through the rear wall 22 and extends in an inner surface of the bottom wall 21b in the up-down direction across the bottom wall 21b in the front-rear direction. The insulator 20 includes a second-contact mounting groove 25 extending across the top wall 21a and the bottom wall 21b in the front-rear direction. The second-contact mounting groove 25 is formed in an inner surface of the top wall 21a in the up-down direction. The second-contact mounting groove 25 is formed in the inner surface of the bottom wall 21b in the up-down direction.

Multiple first-contact mounting grooves 24 are arranged at predetermined intervals in the left-right direction. Multiple second-contact mounting grooves 25 are arranged at predetermined intervals in the left-right direction. An interval between two second-contact mounting grooves 25 that are adjacent to each other in the left-right direction is larger than that between two first-contact mounting grooves 24 that are adjacent to each other in the left-right direction. Each of the second-contact mounting grooves 25 is located between two first-contact mounting grooves 24 at opposite sides in the left-right direction.

The insulator 20 includes a fitting mounting groove 26. The fitting mounting groove 26 is located in a lower portion of each of the side walls 21c and is recessed inward from a front end of the side wall 21c. The insulator 20 includes a mounting portion 27 recessed in the whole of the top wall 21a and in parts of the side walls 21c. The insulator 20 includes multiple recesses 27a. The recesses 27a are located in the mounting portion 27 and are recessed downward from an outer surface of the top wall 21a.

The insulator 20 includes a restricting face 27b. The restricting face 27b is located at a front surface of the rear wall 22 that is next to the mounting portion 27 and slopes rearward and obliquely upward. The restricting face 27b is continuous with the outer surface of the top wall 21a and extends obliquely upward in the rear wall 22. The insulator 20 includes holes 27c extending from the front surface of the rear wall 22 next to the mounting portion 27 to a rear surface of the rear wall 22 in the front-rear direction. The holes 27c are symmetrically arranged at right and left or opposite sides of a central part of the rear wall 22 in the left-right direction such that three holes 27c are located at each of the opposite sides of the central part. Each of the holes 27c corresponds to a “mating portion” described in Claims.

The insulator 20 includes a mounting groove 28. The mounting groove 28 is recessed and located inward from each side wall 21c in the left-right direction. The insulator 20 includes a through-hole 28a. The through-hole 28a extends through the insulator 20 from a front part of the mounting groove 28 to the inside of the insertion portion 23 in the up-down direction. The insulator 20 includes a receiving portion 29 recessed in a central part of the side wall 21c in the left-right direction. The insulator 20 includes a recess 29a located at a lower end of the receiving portion 29. The recess 29a is formed such that an inner part of an outermost portion of the side wall 21c in the left-right direction is outwardly cut away.

The first contact 30 is formed by shaping a sheet of, for example, a copper alloy containing, for example, phosphor bronze, beryllium copper, or titanium copper, and having spring elasticity or a Corson alloy into a form illustrated in FIG. 3 with a progressive die (stamping). The first contact 30 is formed only by stamping, for example. The method of forming the first contact 30 is not limited to this example. For example, the method may include, after stamping, bending a workpiece in the thickness direction. The first contact 30 is plated with nickel, serving as an undercoat layer, and is further plated with, for example, gold or tin, serving as a surface layer. Multiple first contacts 30 are arranged at predetermined intervals in the left-right direction.

Each of the first contacts 30 includes an engaging portion 31 having relatively large dimensions in the up-down and front-rear directions. The first contact 30 includes an extending portion 31a extending straight forward from an upper front end of the engaging portion 31. The first contact 30 includes an installation portion 32 extending rearward from a lower end of the engaging portion 31 and having an L-shape. The first contact 30 includes an elastically deformable elastic portion 33 extending forward from a lower front end of the engaging portion 31. The elastic portion 33 extends straight obliquely upward from the lower front end of the engaging portion 31 toward the insertion opening 23a located in front of the elastic portion 33. The elastic portion 33 is elastically deformable in the up-down direction.

The first contact 30 includes a contact piece 34 connecting to the elastic portion 33. The contact piece 34 extends from a front end of the elastic portion 33 toward the insertion opening 23a of the insertion portion 23 while being at an obtuse angle to the elastic portion 33. The contact piece 34 includes the contact portion 35 and the removing portion 36. The contact portion 35 is located adjacent to the elastic portion 33, protrudes upward, and has a mound-like shape. The removing portion 36 is located closer to the insertion opening 23a of the insertion portion 23 than the contact portion 35. The removing portion 36 is located at a front end of the contact piece 34, protrudes upward, and has a mound-like shape. The contact portion 35 and the removing portion 36 are spaced apart from each other at a predetermined distance in the front-rear direction. The contact piece 34 extends toward the insertion opening 23a while being angled relative to the elastic portion 33 in the direction opposite to the direction in which the contact portion 35 protrudes from the contact piece 34. The contact piece 34 may be elastically deformable like the elastic portion 33.

As illustrated in FIGS. 17 to 19, which will be described later, the contact portion 35 includes a first sloped face 35a, a rounded apex part 35b, and a second sloped face 35c. The first sloped face 35a is located on a front side of the contact portion 35 and slopes obliquely upward and rearward. The apex part 35b is continuous with the first sloped face 35a. The second sloped face 35c slopes obliquely downward and rearward from the apex part 35b. The removing portion 36 includes a first sloped face 36a, a rounded apex part 36b, and a second sloped face 36c. The first sloped face 36a is located on a front side of the removing portion 36 and slopes obliquely upward and rearward. The apex part 36b is continuous with the first sloped face 36a. The second sloped face 36c slopes obliquely downward and rearward from the apex part 36b.

The second contact 40a is formed by shaping a sheet of any metal material into a form illustrated in FIG. 3 with a progressive die (stamping). The second contact 40a is formed only by stamping, for example. The method of forming the second contact 40a is not limited to this example. For example, the method may include, after stamping, bending a workpiece in the thickness direction. Multiple second contacts 40a are arranged at predetermined intervals in the left-right direction.

Each of the second contacts 40a includes an installation portion 41a defining a lower end of the second contact 40a. The second contact 40a includes a base portion 42a extending rearward from the installation portion 41a and having a J-shape. The second contact 40a includes an engaging portion 43a located at a rear end of the base portion 42a and having relatively large dimensions. The second contact 40a includes a contact piece 44a extending straight forward from an upper front end of the engaging portion 43a. A tip part of the base portion 42a, that is, a tip part of the contact piece 44a protrudes downward and has a mound-like shape.

The fitting 40b is formed by shaping a sheet of any metal material into a form illustrated in FIG. 3 with a progressive die (stamping). The fitting 40b is formed only by stamping, for example. The method of forming the fitting 40b is not limited to this example. For example, the method may include, after stamping, bending a workpiece in the thickness direction. Two fittings 40b are respectively arranged on opposite ends of the connector 10 in the left-right direction.

Each of the fittings 40b includes an installation portion 41b defining a lower end of the fitting 40b. The fitting 40b includes a base portion 42b that is continuous with the installation portion 41b. The base portion 42b has relatively large dimensions in the up-down and front-rear directions to constitute a front half portion of the fitting 40b. The fitting 40b includes an engaging portion 43b extending straight rearward from a central part of the base portion 42b in the up-down direction.

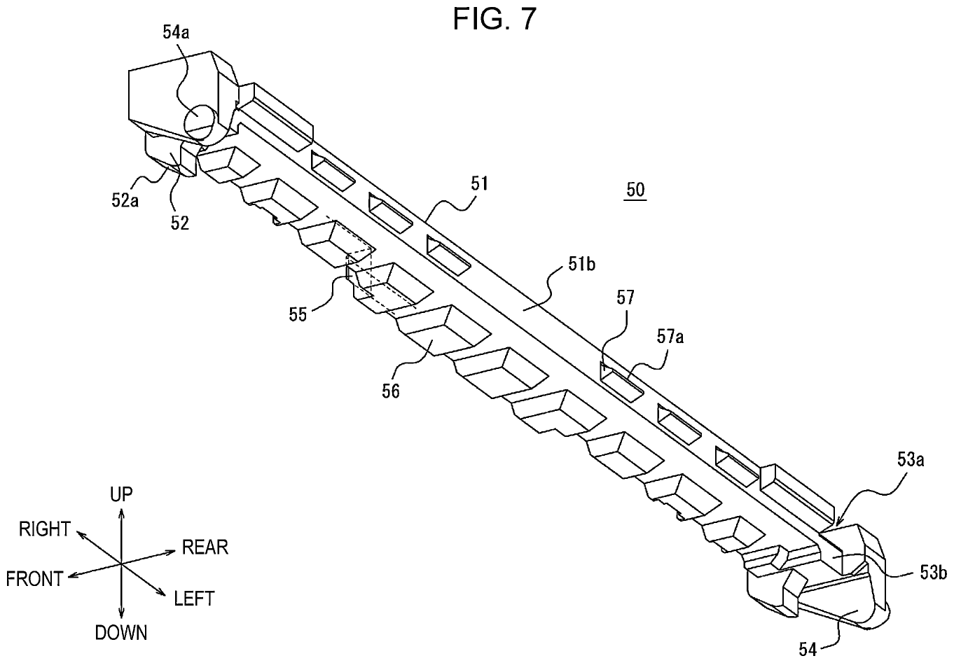

FIG. 7 is an upward perspective view of the actuator 50 alone in FIG. 3. The configuration of the actuator 50 will be mainly described with reference to FIGS. 3 and 7.

The actuator 50 is a bilaterally symmetrical plate-shaped member made of an insulating heat-resistant synthetic resin material formed by injection molding and extending in the left-right direction, as illustrated in FIGS. 3 and 7. The shape of the actuator 50 is not limited to this example. The actuator 50 may have a bilaterally asymmetrical shape. The actuator 50 includes a plate-shaped base portion 51 extending in the left-right direction. The actuator 50 includes a first outer surface 51a defining a front surface of the base portion 51 and a second outer surface 51b defining a rear surface of the base portion 51. The first outer surface 51a and the second outer surface 51b face in the insertion/removal direction of the connection object 70 relative to the connector 10.

The actuator 50 includes two locking protrusions 52 protruding downward from left and right or opposite sides of a front end part of the base portion 51. The locking protrusions 52 each include a sloped face 52a located on a front lower part of the locking protrusion 52 and sloping obliquely downward and rearward. The actuator 50 includes a hollow 53a located directly above each of the locking protrusions 52 and formed by cutting away a part of the base portion 51. The actuator 50 includes a mounting portion 53b located above each of the locking protrusions 52. The mounting portion 53b extends in the front-rear direction below the hollow 53a. The mounting portions 53b are respectively located on opposite ends of the actuator 50 in the longitudinal direction of the connector 10.

The actuator 50 includes pivots 54 located on left and right or opposite ends of the base portion 51. The actuator 50 includes circular protrusions 54a protruding outward from outer surfaces of lowermost parts of the pivots 54 in the left-right direction. The actuator 50 includes an operating portion 55 located at the middle of the front end part of the base portion 51 and protruding forward. The operating portion 55 is located between the two mounting portions 53b on the first outer surface 51a. The actuator 50 includes multiple raised portions 56 protruding downward from a lower surface of the base portion 51.

The actuator 50 includes projections 57 located between the two mounting portions 53b on the second outer surface 51b opposite the first outer surface 51a. Each of the projections 57 corresponds to a “mated portion” described in Claims. The projections 57 are symmetrically arranged at right and left or opposite sides of a central part of the second outer surface 51b in the left-right direction such that three projections are located at each of the opposite sides of the central part. The projections 57 are located at positions corresponding to opposite ends of the operating portion 55 in the longitudinal direction of the connector 10. More specifically, the positions of two projections 57 located at the right and left or opposite sides of the central part of the second outer surface 51b in the left-right direction substantially coincide with the positions of the opposite ends of the operating portion 55 in the left-right direction. The actuator 50 includes a sloped face 57a continuous with the second outer surface 51b and sloping therefrom at each of the projections 57. The sloped face 57a included in the projection 57, serving as a mated portion, corresponds to an upper outer face of the projection 57.

The pressing member 60 is formed by shaping a sheet of any metal material into a form illustrated in FIG. 3 with a progressive die (stamping). The pressing member 60 is formed by, for example, bending a workpiece in the thickness direction after stamping, and is thus L-shaped as a whole. The method of forming the pressing member 60 is not limited to this example. For example, the method may include only stamping. Two pressing members 60 are respectively arranged on the opposite ends of the connector 10 in the left-right direction.

Each of the pressing members 60 includes an engaging portion 61 located in a rear part of the pressing member 60 and having a relatively large dimension in the left-right direction. The pressing member 60 includes an installation portion 62 extending downward from a rear end of the engaging portion 61 while being bent in a J-shape. The pressing member 60 includes a contact portion 63 extending straight from a front end of the engaging portion 61 in the front-rear direction.

In the connector 10, each of the first contacts 30 is mounted in the insulator 20. For example, the first contact 30 is mounted on the rear wall 22 such that the engaging portion 31 engages with the first-contact mounting groove 24 of the insulator 20. Similarly, each of the second contacts 40a is mounted in the insulator 20 such that the engaging portion 43a engages with the second-contact mounting groove 25 of the insulator 20. Each of the fittings 40b is mounted in the insulator 20 such that the engaging portion 43b engages with the fitting mounting groove 26 of the insulator 20. Each of the pressing members 60 is mounted on the insulator 20 such that the engaging portion 61 engages with the mounting groove 28 of the insulator 20.

In the connector 10, the actuator 50 is disposed on the mounting portion 27 of the insulator 20. The actuator 50 in the closed position is supported from below by the insulator 20. For example, each of the pivots 54 of the actuator 50 is held in the receiving portion 29 of the insulator 20 and is in contact with a bottom face of the receiving portion 29. In this state, the protrusion 54a protruding from the pivot 54 of the actuator 50 mates with the recess 29a of the receiving portion 29 of the insulator 20. If the actuator 50 is moving upward, the protrusion 54a can be caught by an upper face of the recess 29a, so that the actuator 50 is less likely to separate from the insulator 20. For example, each of the raised portions 56 of the actuator 50 fits in the recess 27a of the insulator 20 and is in contact with a bottom face of the recess 27a.

In this state, as illustrated in FIG. 8, which will be described later, a lower face of each mounting portion 53b of the actuator 50 faces a bottom face of a central portion of the mounting groove 28 of the insulator 20 in the front-rear direction, and the central portion is located behind the through-hole 28a. The two mounting portions 53b allow the actuator 50 to be mounted on the insulator 20.

More specifically, the mounting portions 53b allow the actuator 50 to be mounted on the insulator 20 in response to receiving an urging force applied from the open position side by the pressing members 60. In the connector 10, the actuator 50 is pressed from above by the pressing members 60 mounted on the insulator 20 and is supported from below by the insulator 20. For example, the contact portion 63 of each pressing member 60 is located in the hollow 53a of the actuator 50 and is in contact from above with a bottom face of the hollow 53a, for example, an upper face of the mounting portion 53b.

Referring to, for example, FIG. 1, the connector 10 is installed on a circuit formation surface formed on an upper surface of the circuit board CB disposed substantially parallel to the insertion/removal direction. More specifically, the installation portion 32 of the first contact 30 is placed on a soldering paste applied to a pattern on the circuit board CB. The installation portion 41a of the second contact 40a is placed on the soldering paste applied to the pattern on the circuit board CB. The installation portion 41b of the fitting 40b is placed on the soldering paste applied to the pattern on the circuit board CB. The installation portion 62 of the pressing member 60 is placed on the soldering paste applied to the pattern on the circuit board CB.

The installation portion 32, the installation portion 41a, the installation portion 41b, and the installation portion 62 are soldered to the pattern by heating and melting the soldering paste in, for example, a reflow furnace. Thus, the installation of the connector 10 on the circuit board CB is completed. For example, an electronic component different from the connector 10, for example, a CPU (central processing unit), a controller, or a memory, is installed on the circuit formation surface of the circuit board CB.

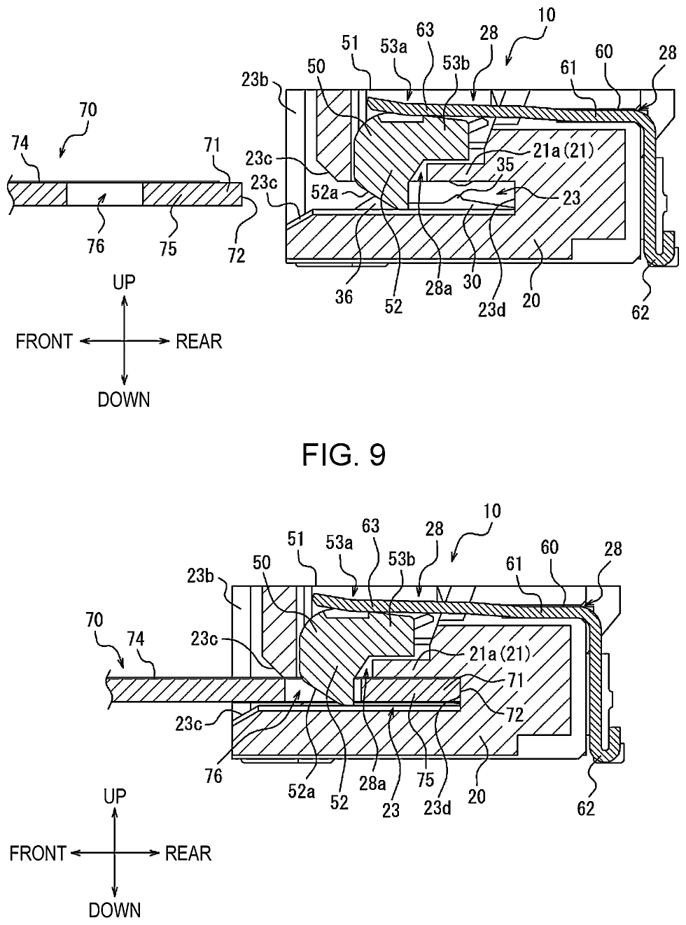

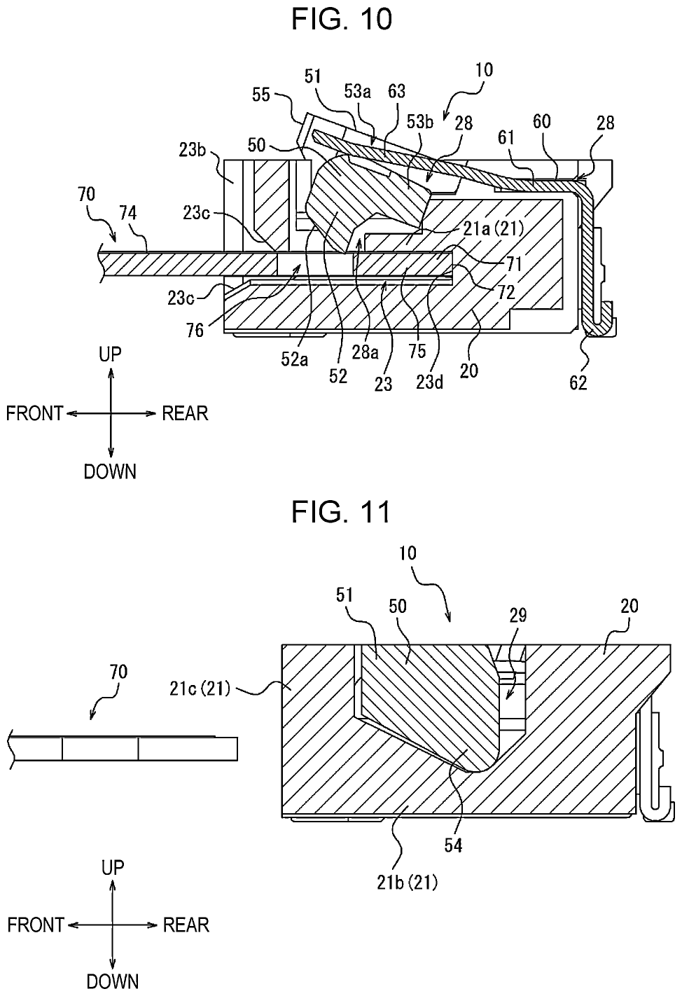

Functions of the connector 10 according to an embodiment will now be mainly described with reference to FIGS. 8 to 19. FIG. 8 is a cross-sectional view taken along arrow line VIII-VIII in FIG. 1. FIG. 9 is a cross-sectional view taken along arrow line IX-IX in FIG. 4. FIG. 10 is a cross-sectional view taken along arrow line X-X in FIG. 5. FIGS. 8 to 10 illustrate sections of the configuration related to the locking protrusion 52 of the actuator 50 and the pressing member 60.

As illustrated in FIG. 8, the pressing member 60 is mounted on the insulator 20 such that the engaging portion 61 engages with the mounting groove 28 of the insulator 20. When the actuator 50 is in the closed position in the non-insertion state, a lower face of the contact portion 63 of the pressing member 60 is in contact, from the open position side, with the bottom wall of the hollow 53a, or the upper face of the mounting portion 53b, of the actuator 50. At this time, the contact portion 63 of the pressing member 60 is not elastically deformed or is slightly elastically deformed. A part of the mounting portion 53b of the actuator 50 that is located at the rear of the locking protrusion 52 faces an upper surface of the top wall 21a of the insulator 20. The locking protrusion 52 of the actuator 50 protrudes in the insertion portion 23 through the through-hole 28a of the insulator 20.

When the connection object 70 is inserted into the insertion portion 23 of the connector 10, for example, one end of the connection object 70 enters the insertion portion 23 along each first angled face 23b and each second angled face 23c of the insulator 20. If the connection object 70 to be inserted is slightly skewed relative to the insertion portion 23 in the left-right direction, each guide 77 of the connection object 70 can slide on the first angled face 23b of the insulator 20, so that the connection object 70 can be guided into the insertion portion 23. Similarly, if the connection object 70 to be inserted is slightly skewed relative to the insertion portion 23 in the up-down direction, the end of the connection object 70 can slide on the second angled face 23c of the insulator 20, so that the connection object 70 can be guided into the insertion portion 23.

When the connection object 70 further moves into the insertion portion 23 and enters the partially inserted state, each retainer 75 of the connection object 70 contacts the locking protrusion 52 of the actuator 50. At this time, the contact between the connection object 70 and the sloped face 52a, located on the removal side, of the locking protrusion 52 produces a reaction force toward the open position of the actuator 50. Therefore, a moment of force toward the open position acts on the actuator 50.

When the connection object 70 moves further inward in the insertion portion 23 while the locking protrusion 52 is in contact with the retainer 75, the moment of force toward the open position causes the actuator 50 to rotate to the open position. The rotation of the actuator 50 to the open position increases the amount of elastic deformation of the contact portion 63 of the pressing member 60. This increases an urging force applied to the actuator 50 toward the closed position by the contact portion 63 of the pressing member 60. At this time, the locking protrusion 52 of the actuator 50 rides on an upper face of the retainer 75 of the connection object 70. As the connection object 70 moves rearward, the retainer 75 slides relative to the tip of the locking protrusion 52. At this time, the locking protrusion 52 presses the connection object 70 toward the first contact 30 in the partially inserted state. The locking protrusion 52 is located closer to the removing portion 36 than to the contact portion 35 of the first contact 30.

As illustrated in FIG. 9, in the fully inserted state, the retainer 75 of the connection object 70 is held in the insertion portion 23 past the locking protrusion 52 of the actuator 50. For example, the end face 72 of the connection object 70 is against the inner face 23d of the insertion portion 23 of the insulator 20. At this time, the locking protrusion 52 is not in contact with the retainer 75 in the up-down direction, so that the actuator 50 automatically rotates to the closed position due to the urging force from the pressing member 60. In such a closed position of the actuator 50, the locking protrusion 52 engages with the lock recess 76 of the connection object 70. Thus, the actuator 50 retains the connection object 70 held in the insertion portion 23. If a user tries to forcedly remove the connection object 70 in such a state, the retainer 75 of the connection object 70 will contact the locking protrusion 52. Therefore, the connection object 70 can be more effectively retained.

As described above, the connector 10 retains the connection object 70 inserted by only one action of inserting the connection object 70 without the need for causing, for example, an operator or an assembly apparatus, to perform any operation on the operating portion 55 of the actuator 50.

As illustrated in FIG. 10, to remove the connection object 70 from the connector 10, for example, an operator or an assembly apparatus operates the operating portion 55 of the actuator 50 to maintain the actuator 50 in the open position. The operating portion 55 is operated to open the actuator 50 from the closed position to the open position. At this time, the contact portion 63 of the pressing member 60 significantly deforms elastically upward. The pressing member 60 urges the actuator 50 toward the closed position when the actuator 50 is in the open position. The urging force applied to the actuator 50 toward the closed position by the contact portion 63 of the pressing member 60 further increases.

The actuator 50 is maintained in the open position due to a balance between such an urging force, a force acting on the operating portion 55 to move the actuator 50 toward the open position, and a reaction force acting from the insulator 20 on the actuator 50.

When the connector 10 is in the open position, the locking protrusion 52 of the actuator 50 disengages from the lock recess 76 of the connection object 70. The engagement between the locking protrusion 52 and the lock recess 76 is released. Thus, the connection object 70 can be removed from the connector 10.

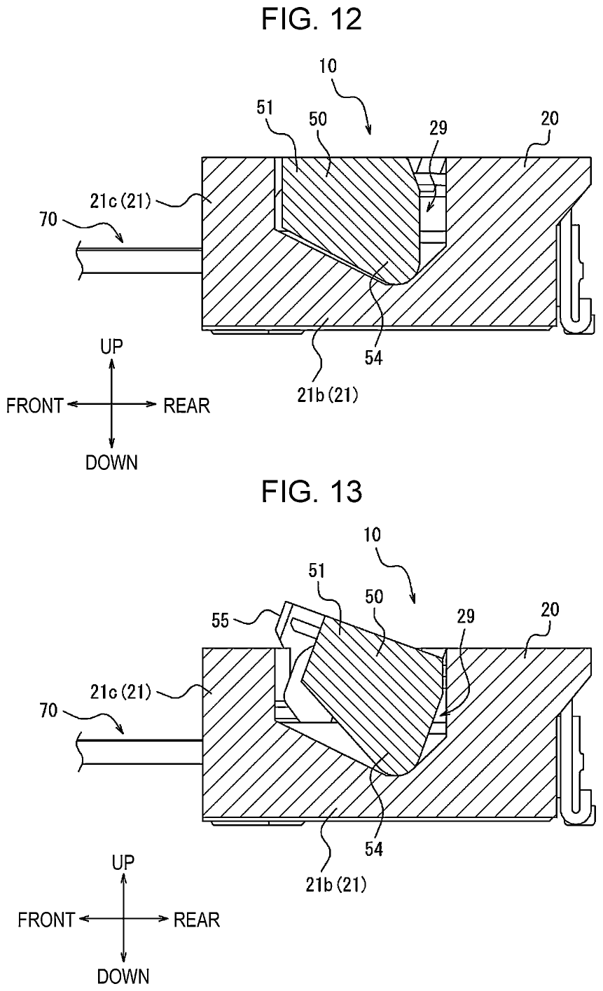

FIG. 11 is a cross-sectional view taken along arrow line XI-XI in FIG. 1. FIG. 12 is a cross-sectional view taken along arrow line XII-XII in FIG. 4. FIG. 13 is a cross-sectional view taken along arrow line XIII-XIII in FIG. 5. FIGS. 11 to 13 illustrate sections of the configuration related to the pivot 54 of the actuator 50 and the receiving portion 29 of the insulator 20.

As illustrated in FIGS. 11 to 13, during transition from the non-insertion state to the partially inserted state and further to the fully inserted state, the actuator 50 shifts from the closed position to a position between the closed position and the open position and returns to the closed position. In addition, when the connection object 70 is removed from the connector 10 in the fully inserted state, the actuator 50 shifts to the open position in response to receiving, on the operating portion 55, an operation of opening the actuator 50 from the closed position to the open position.

During such a shift, the pivot 54 of the actuator 50 is held in the receiving portion 29 of the insulator 20 and is in contact with the bottom face of the receiving portion 29 at all times. Such contact between the pivot 54 and the bottom face of the receiving portion 29 causes the actuator 50 to be rotatable relative to the insulator 20. In addition, when rotating, the actuator 50 is kept from moving upward by the urging force toward the closed position applied by the pressing member 60 and an engagement structure formed by the protrusion 54a and the recess 29a. This reduces separation of the actuator 50 from the insulator 20.

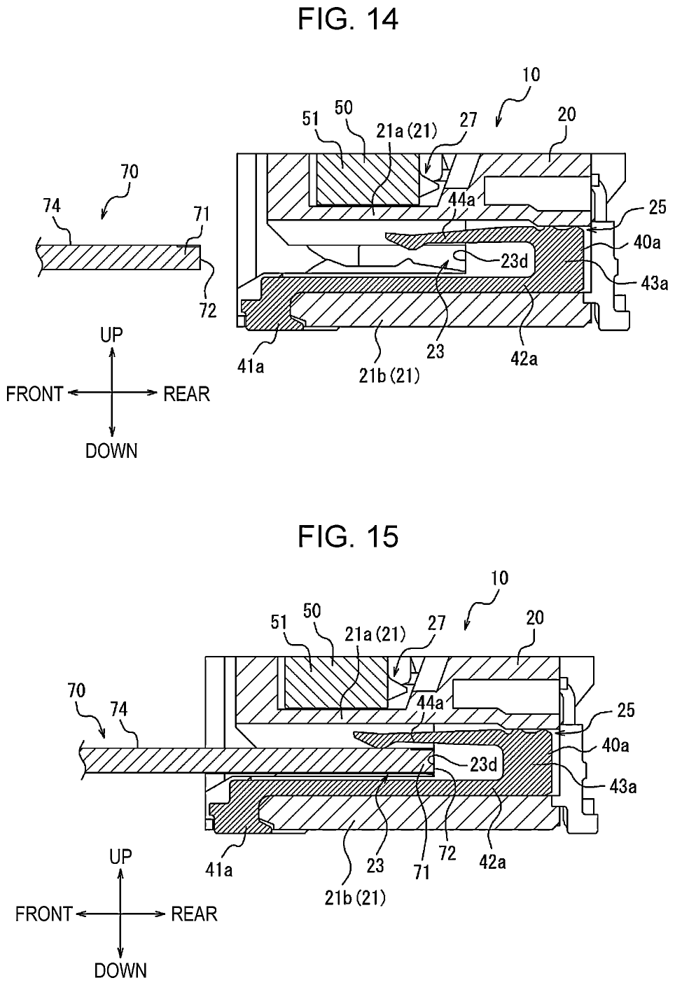

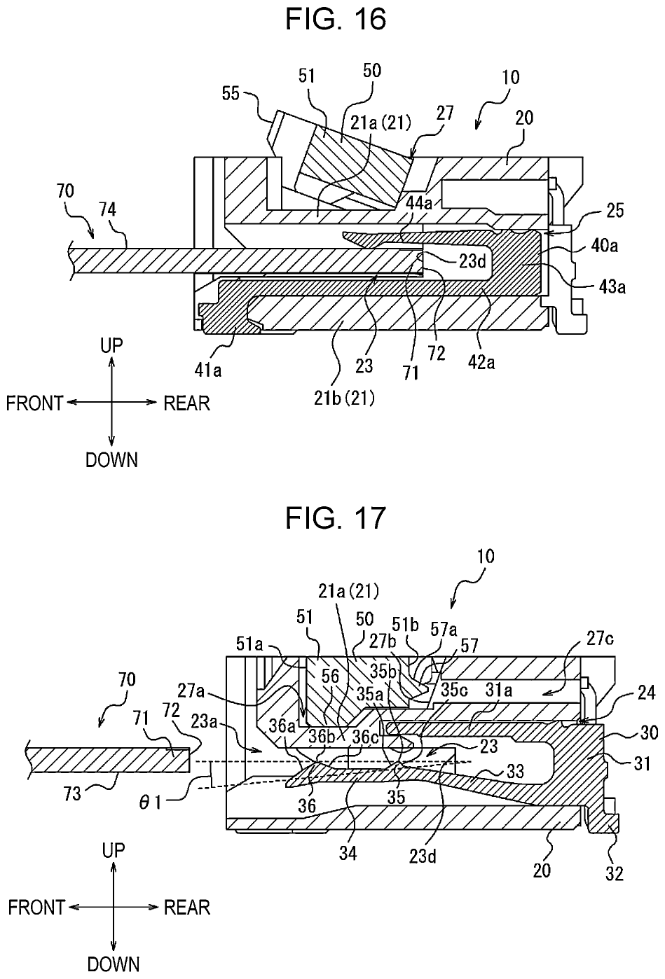

FIG. 14 is a cross-sectional view taken along arrow line XIV-XIV in FIG. 1. FIG. 15 is a cross-sectional view taken along arrow line XV-XV in FIG. 4. FIG. 16 is a cross-sectional view taken along arrow line XVI-XVI in FIG. 5. FIGS. 14 to 16 illustrate sections of the configuration related to the second contact 40a.

As illustrated in FIG. 14, after the engaging portion 43a of the second contact 40a is mounted in the second-contact mounting groove 25 of the insulator 20, the contact piece 44a is partly exposed in the insertion portion 23. For example, in the non-insertion state, the mound-shaped tip part of the contact piece 44a is exposed in the insertion portion 23. The contact piece 44a of the second contact 40a can be elastically deformed upward in the second-contact mounting groove 25.

As illustrated in FIGS. 14 to 16, when the end face 72 of the connection object 70 comes into contact with the inner face 23d of the insertion portion 23 of the insulator 20 upon transition from the non-insertion state to the fully inserted state, the J-shaped base portion 42a of the second contact 40a receives the end portion 71 of the connection object 70. The second contact 40a receives the connection object 70 such that the end portion 71 is located between a lower part of the base portion 42a that extends in the front-rear direction and the contact piece 44a located in an upper part of the base portion 42a.

As illustrated in FIGS. 15 and 16, in the fully inserted state, the tip part of the contact piece 44a of the second contact 40a contacts the outer cover 74 of the connection object 70. At this time, the contact piece 44a elastically deforms upward and thus applies a downward urging force to the connection object 70. The second contact 40a downwardly presses the connection object 70 in response to the contact between the contact piece 44a and the outer cover 74.

As illustrated in FIGS. 14 and 15, while the connector 10 is in the closed state, the lower surface of the base portion 51 of the actuator 50 faces a bottom surface of the mounting portion 27 of the insulator 20, or the upper surface of the top wall 21a, with a slight gap therebetween.

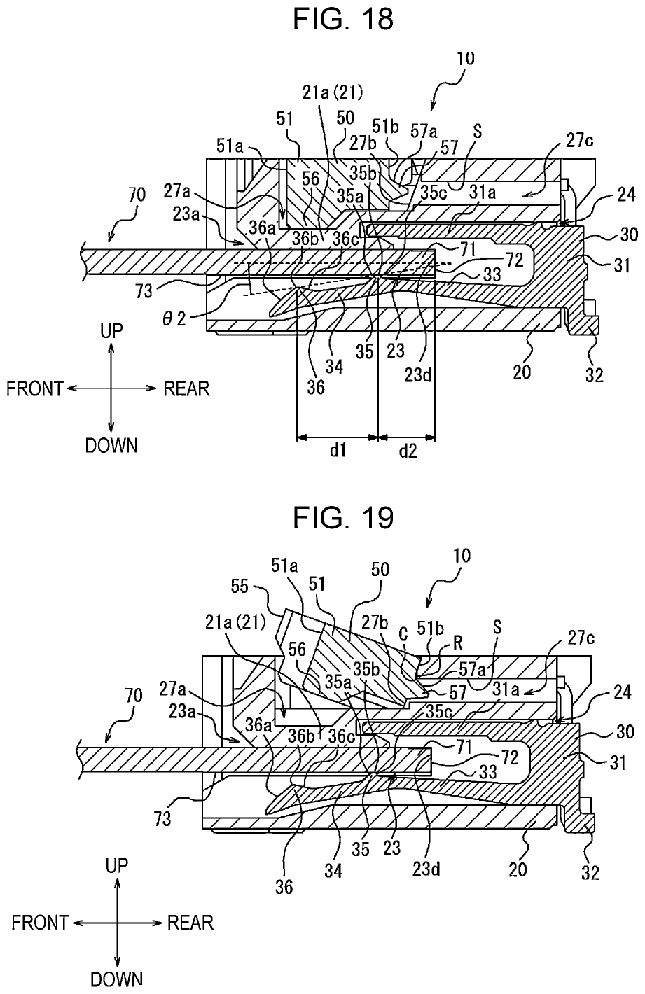

FIG. 17 is a cross-sectional view taken along arrow line XVII-XVII in FIG. 1. FIG. 18 is a cross-sectional view taken along arrow line XVIII-XVIII in FIG. 4. FIG. 19 is a cross-sectional view taken along arrow line XIX-XIX in FIG. 5. FIGS. 17 to 19 illustrate sections of the configuration related to the first contact 30.

As illustrated in FIG. 17, after the first contact 30 is mounted in the first-contact mounting groove 24, the contact piece 34 is partly exposed in the insertion portion 23. For example, in the non-insertion state, the contact portion 35 and the removing portion 36 of the contact piece 34 are exposed in the insertion portion 23. At this time, the contact piece 34 is maintained while extending substantially horizontally from the elastic portion 33. A straight line connecting the apex part 35b of the contact portion 35 and the apex part 36b of the removing portion 36 extends substantially horizontally. The elastic portion 33 of the first contact 30 can be elastically deformed downward in the first-contact mounting groove 24.

The removing portion 36 contacts the signal line 73 of the connection object 70 in the partially inserted state where the connection object 70 is inserted into the insertion portion 23. For example, the apex part 36b of the removing portion 36 contacts the signal line 73. At this time, the contact portion 35 is not in contact with the connection object 70. In the partially inserted state, the apex part 36b of the removing portion 36 in contact with the signal line 73 and the contact portion 35 are exposed in the insertion portion 23.

More specifically, when the connection object 70 moves inward in the insertion portion 23 in the non-insertion state, the end of the connection object 70 contacts the first sloped face 36a of the removing portion 36. At this time, the contact between the connection object 70 and the first sloped face 36a of the first contact 30 produces a reaction force that causes the elastic portion 33 of the first contact 30 to be elastically deformed downward. Therefore, as the connection object 70 moves inward in the insertion portion 23, or as the connection object 70 moves in the insertion direction in which the connection object 70 is inserted into the insertion portion 23, the elastic portion 33 of the first contact 30 is elastically deformed downward, so that the apex part 36b of the removing portion 36 comes into contact with the signal line 73.

When the connection object 70 moves further inward in the insertion portion 23, the signal line 73 slides relative to the apex part 36b of the removing portion 36. For a period of time between when the apex part 36b of the removing portion 36 contacts the signal line 73 and when the end of the connection object 70 contacts the first sloped face 35a of the contact portion 35, the contact piece 34 is maintained while being inclined obliquely downward from the elastic portion 33 toward the insertion opening 23a at a first angle θ1. The straight line connecting the apex part 35b of the contact portion 35 and the apex part 36b of the removing portion 36 is inclined obliquely downward and forward at the first angle θ1 relative to the horizontal direction.

At this time, the apex part 35b of the contact portion 35 is located closer to the connection object 70 than the apex part 36b of the removing portion 36 in the direction in which the contact portion 35 protrudes from the contact piece 34. For example, the apex part 35b of the contact portion 35 is located at a level higher than the apex part 36b of the removing portion 36. The apex part 35b of the contact portion 35 is located above the apex part 36b of the removing portion 36.

As illustrated in FIG. 18, the contact portion 35 contacts the signal line 73 of the connection object 70 in the fully inserted state where the connection object 70 is held in the insertion portion 23. For example, the apex part 35b of the contact portion 35 contacts the signal line 73. In the fully inserted state, the elastic portion 33 is elastically deformed downward by a larger amount than that in the partially inserted state, and the removing portion 36 is thus apart from the connection object 70. The removing portion 36 is not in contact with the connection object 70. In the fully inserted state, only the apex part 35b of the contact portion 35 in contact with the signal line 73 is exposed in the insertion portion 23.

More specifically, when the connection object 70 moves further inward in the insertion portion 23 in the partially inserted state, the end of the connection object 70 contacts the first sloped face 35a of the contact portion 35. At this time, the contact between the connection object 70 and the first sloped face 35a of the first contact 30 produces a reaction force that causes the elastic portion 33 of the first contact 30 to be further elastically deformed downward. Therefore, as the connection object 70 moves inward in the insertion portion 23, the elastic portion 33 of the first contact 30 is further elastically deformed downward, so that the apex part 36b of the removing portion 36 is further away from the signal line 73. In contrast, the apex part 35b of the contact portion 35 contacts the signal line 73.

While the connection object 70 moves further inward in the insertion portion 23 until the end face 72 comes into contact with the inner face 23d of the insertion portion 23, the signal line 73 slides relative to the apex part 35b of the contact portion 35. Once the apex part 35b of the contact portion 35 contacts the signal line 73, the contact piece 34 is maintained while being inclined obliquely downward from the elastic portion 33 toward the insertion opening 23a at a second angle θ2. The straight line connecting the apex part 35b of the contact portion 35 and the apex part 36b of the removing portion 36 is inclined obliquely downward and forward at the second angle θ2 relative to the horizontal direction. After the end face 72 of the connection object 70 comes into contact with the inner face 23d, or after the connection object 70 completely enters the fully inserted state, the contact piece 34 is maintained at the second angle θ2. The second angle θ2 in the fully inserted state is larger than the first angle θ1 in the partially inserted state.

A distance d1 between a first point of contact between the removing portion 36 and the signal line 73 in the partially inserted state and a second point of contact between the contact portion 35 and the signal line 73 in the fully inserted state in the insertion direction is larger than a distance d2 between the second point of contact and the inner face 23d in the insertion direction.

The top wall 21a of the insulator 20 is located between the actuator 50 and the contact and removing portions 35 and 36 of the first contact 30. In the partially inserted state where the connection object 70 is inserted into the insertion portion 23, the connection object 70 is held between the removing portion 36 and the top wall 21a in the direction in which the contact portion 35 protrudes from the contact piece 34. In the fully inserted state where the connection object 70 is held in the insertion portion 23, the connection object 70 is held between the contact portion 35 and the top wall 21a in the direction in which the contact portion 35 protrudes from the contact piece 34.

For the first-contact mounting groove 24 illustrated in FIGS. 17 to 19, its width in the direction orthogonal to the direction in which the contact portion 35 protrudes from the contact piece 34 and orthogonal to the insertion direction in which the connection object 70 is inserted is uniform in the front-rear direction. A width of the first-contact mounting groove 24 at the removing portion 36 and a width thereof at the contact portion 35 are equal to each other. For example, these widths may be slightly larger than the thickness of the first contact 30.

The width of the removing portion 36 in the direction orthogonal to the direction in which the contact portion 35 protrudes from the contact piece 34 and orthogonal to the insertion direction in which the connection object 70 is inserted is larger than or equal to the width of the contact portion 35 in that direction.

When the first contact 30 is viewed from above, the removing portion 36 is aligned with at least part of the contact portion 35 in the direction orthogonal to the direction in which the contact portion 35 protrudes from the contact piece 34 and orthogonal to the insertion direction in which the connection object 70 is inserted. For example, the contact portion 35 is aligned with the removing portion 36 on a straight line connecting the contact portion 35 and the removing portion 36 such that the straight light is substantially parallel to the insertion direction. The contact portion 35 and the removing portion 36 are located on the same straight line substantially parallel to the insertion direction in which the connection object 70 is inserted.

As illustrated in FIGS. 18 and 19, a mating portion of the insulator 20 mates, from the open position side of the actuator 50, with a mated portion of the actuator 50. The mated portion of the actuator 50 includes the projection 57 projecting from the second outer surface 51b toward the mating portion of the insulator 20. The projection 57 projects from the second outer surface 51b in the insertion direction in which the connection object 70 is inserted. The mating portion of the insulator 20 includes the hole 27c to receive the projection 57.

As an example, when the actuator 50 is in the closed position, the mated portion of the actuator 50 is apart from the mating portion of the insulator 20 and does not mate with the mating portion. When the actuator 50 is in the closed position, the projection 57 of the actuator 50 is exposed outside the hole 27c of the insulator 20. When the actuator 50 is in the closed position, the mated portion of the actuator 50 does not face an open-position-side inner face S of the mating portion of the insulator 20 in the direction orthogonal to the longitudinal direction of the connector 10 and orthogonal to the insertion/removal direction.

On the other hand, when the actuator 50 is in the open position, the mated portion of the actuator 50 mates with the mating portion of the insulator 20. When the actuator 50 is in the open position, the projection 57 of the actuator 50 is received in the hole 27c of the insulator 20. When the actuator 50 is in the open position, the mated portion of the actuator 50 faces the open-position-side inner face S of the mating portion of the insulator 20 in the direction orthogonal to the longitudinal direction of the connector 10 and orthogonal to the insertion/removal direction.

As described above, when the actuator 50 moves to the open position in response to receiving, on the operating portion 55, an operation of opening the actuator 50 from the closed position to the open position, the actuator 50 experiences slight rearward translational movement. Thus, the projection 57, which has been exposed outside the hole 27c in the closed state of the connector 10, is received in the hole 27c in the open state of the connector 10.

When the projection 57 is received in the hole 27c in the open state of the connector 10, the sloped face 57a of the projection 57 faces the open-position-side inner face S of the hole 27c. In the open state of the connector 10, the sloped face 57a is inclined obliquely downward and rearward relative to the open-position-side inner face S of the hole 27c. In the open state of the connector 10, a distance between the sloped face 57a and the open-position-side inner face S of the hole 27c in the up-down direction increases rearward.

The projection 57 includes an adjacent portion R adjacent to the second outer surface 51b on the open position side. The adjacent portion R faces an edge C of the insulator 20 that is located at the hole 27c of the insulator 20 on the open position side. In the open state of the connector 10, the adjacent portion R of the actuator 50 is located on the closed position side relative to the edge C and is in proximity to or in contact with the edge C.

In response to a force exerted on the operating portion 55 to move the actuator 50 to the open position, the actuator 50 is bending upward in the up-down direction around the operating portion 55 between the two mounting portions 53b. In such a case, the mating portion of the insulator 20 mates with the mated portion of the actuator 50 and applies a reaction force acting from the open position side to the closed position side to the actuator 50. For example, the hole 27c of the insulator 20 receives the projection 57 of the actuator 50, and the edge C contacts the adjacent portion R of the actuator 50, so that the insulator 20 applies a reaction force acting from the open position side to the closed position side to the actuator 50.

Thus, the mating portion of the insulator 20 applies a force to the mated portion of the actuator 50 to regulate upward bending of the actuator 50 between the two mounting portions 53b. The mating portion of the insulator 20 reduces upward bending of the actuator 50 that may occur around the operating portion 55 between the two mounting portions 53b.

As illustrated in FIGS. 3 and 7, sets each including the mated portion of the actuator 50 and the mating portion of the insulator 20 are located at the positions corresponding to the opposite ends of the operating portion 55 in the longitudinal direction of the connector 10. More specifically, the positions of two sets of the mated and mating portions located at right and left or opposite sides of the central portions of the actuator 50 and the insulator 20 in the left-right direction are substantially the same as the positions of the opposite ends of the operating portion 55 in the left-right direction. In addition, more sets each including the mated portion of the actuator 50 and the mating portion of the insulator 20 are located between the operating portion 55 and each of the mounting portions 53b. This allows the above-described effect of reducing bending of the actuator 50 to be exerted more remarkably.

When the actuator 50 is in the open position, the restricting face 27b of the insulator 20 contacts the second outer surface 51b of the actuator 50. The restricting face 27b reduces excessive opening of the actuator 50 relative to the insulator 20 caused by a force exerted on the operating portion 55 to move the actuator 50 to the open position.

The following description will mainly focus on the connector 10. Advantages of the connector 10 will be described below. The same and/or similar description applies to an electronic device including the connector 10.

In an embodiment, the above-described connector 10 can maintain reliability even when reduced in profile. In the connector 10, the actuator 50 includes the mated portion for the operating portion 55 between the two mounting portions 53b, and the insulator 20 includes the mating portion to mate, from the open position side of the actuator 50, with the mated portion. Thus, even when the actuator 50 is bending upward around the operating portion 55 between the two mounting portions 53b in an opening operation because of a reduction in thickness of the actuator 50 accompanied by a reduction in profile of the connector 10, the mating portion of the insulator 20 mates with the mated portion of the actuator 50, thus applying a reaction force acting from the open position side to the closed position side to the actuator 50. This reduces upward bending of the actuator 50 that may occur around the operating portion 55 between the two mounting portions 53b. As a result, if the connector 10 is reduced in profile, for example, a reduction in stability of rotation of the actuator 50, breakage of the actuator 50, and separation of the actuator 50 from the connector 10 can be reduced, so that the reliability of the connector 10 can be maintained. In general, an operator who operates the operating portion 55 of the actuator 50 tends to excessively press the actuator 50 in the opening operation. Even in such a case, for example, breakage of the actuator 50 can be reduced. This results in improved reliability of the connector 10 as a product.

The mated portion includes the projection 57, and the mating portion includes the hole 27c to receive the projection 57. This facilitates engagement between the actuator 50 and the insulator 20 in the open position of the actuator 50. Since the projection 57, serving as the mated portion, projects from the second outer surface 51b toward the mating portion, the projection 57 can be readily received in the hole 27c, serving as the mating portion, even if the actuator 50 is inclined obliquely upward in the open position.

The sloped face 57a included in the mated portion faces the inner face S, which is located on the open position side of the actuator 50, of the mating portion. This provides an effect that is the same as and/or similar to the above-described effect of reducing bending of the actuator 50.

The adjacent portion R of the projection 57 adjacent to the second outer surface 51b on the open position side faces the edge C of the insulator 20 at the mating portion on the open position side. This provides an effect that is the same as and/or similar to the above-described effect of reducing bending of the actuator 50.

The insulator 20 includes the restricting face 27b, which is in contact with the second outer surface 51b in the open position of the actuator 50. This reduces excessive opening of the actuator 50 that exceeds a design value for the insulator 20. In general, an operator who operates the operating portion 55 of the actuator 50 tends to excessively press the actuator 50 in the opening operation. Even in such a case, breakage of the actuator 50 can be reduced. This results in improved reliability of the connector 10 as a product.

The mated portion mates with the mating portion when the actuator 50 is in the open position, and is apart from the mating portion and does not mate with the mating portion when the actuator 50 is in the closed position. During assembly of the connector 10, therefore, the actuator 50 can be disposed on the insulator 20 only by moving the actuator 50 downward from directly above the insulator 20 and placing the actuator 50 on the insulator 20. The assembly of the connector 10 does not need to include moving the actuator 50 downward from above the insulator 20 and then causing rearward translational movement of the actuator 50 to mate the projection 57 with the hole 27c. This results in improved case of assembly of the connector 10.

Sets of the mated and mating portions are located at the positions corresponding to the opposite ends of the operating portion 55 in the longitudinal direction of the connector 10. This ensures engagement at the operating portion 55, at which upward displacement of the actuator 50 caused by bending of the actuator 50 starting from and located between the two mounting portions 53b may be largest. This allows the mating portion of the insulator 20 to apply a reaction force acting from the open position side to the closed position side to the mated portion of the actuator 50 at the operating portion 55, at which upward displacement of the actuator 50 may be largest. As a result, upward bending of the actuator 50 that may occur around the operating portion 55 between the two mounting portions 53b can be reduced more effectively.

Each of the mounting portions 53b allows the actuator 50 to be mounted on the insulator 20 in response to receiving an urging force applied from the open position side of the actuator 50 by the pressing member 60. Thus, the actuator 50 can be stably mounted on the insulator 20 with an urging force applied by the pressing member 60. An urging force acting from the pressing member 60 on the actuator 50 gradually increases from the closed position toward the open position, so that the opening and closing operations of the actuator 50 relative to the insulator 20 can be smoothly performed with spring elasticity of the pressing member 60.

The connector 10 enables improvement of reliability. For example, in an embodiment, the connector 10 can remove foreign matter adhering to the connection object 70. For example, in the partially inserted state where the connection object 70 is inserted into the insertion portion 23, the removing portion 36 contacts the signal line 73 of the connection object 70. Thus, foreign matter adhering to the signal line 73 of the connection object 70 can be removed. More specifically, the foreign matter adheres to the removing portion 36 of the first contact 30 in the partially inserted state, and is then removed from the signal line 73 of the connection object 70 since the removing portion 36 is apart from the signal line 73 in the fully inserted state. In the partially inserted state, the signal line 73 of the connection object 70 slides relative to the apex part 36b of the removing portion 36. Thus, the foreign matter is removed in a predetermined region of the signal line 73 of the connection object 70 in the insertion direction.

In the partially inserted state, the apex part 35b of the contact portion 35 is located closer to the connection object 70 than the apex part 36b of the removing portion 36 in the direction in which the contact portion 35 protrudes from the contact piece 34. This allows the signal line 73 of the connection object 70 to readily contact the apex part 35b when the connection object 70 is moved further inward in the insertion portion 23 and enters the fully inserted state.

The removing portion 36 is aligned with at least part of the contact portion 35 in the direction orthogonal to the direction in which the contact portion 35 protrudes from the contact piece 34 and orthogonal to the insertion direction in which the connection object 70 is inserted. This ensures that, after the foreign matter adhering to the signal line 73 of the connection object 70 is removed by the removing portion 36, a foreign-matter-free face of the signal line 73 that is subjected to foreign matter removal is brought into contact with the contact portion 35 of the first contact 30.

The width of the removing portion 36 in the direction orthogonal to the direction in which the contact portion 35 protrudes from the contact piece 34 and orthogonal to the insertion direction in which the connection object 70 is inserted is larger than or equal to the width of the contact portion 35 in that direction. This ensures that, after the foreign matter adhering to the signal line 73 of the connection object 70 is removed by the removing portion 36, the foreign-matter-free face of the signal line 73 is brought into contact with the contact portion 35 of the first contact 30.

The contact piece 34 extends toward the insertion opening 23a of the insertion portion 23 while being angled relative to the elastic portion 33 in the direction opposite to the direction in which the contact portion 35 protrudes from the contact piece 34. This allows separation of the removing portion 36 from the signal line 73 and contact at a single point between the contact portion 35 and the signal line 73 in the fully inserted state. In the first contact 30, the removing portion 36 is apart from and in front of the elastic portion 33 and the contact portion 35, and is located at an end of the first contact 30 that is adjacent to the insertion opening 23a. This reduces an excess of pressure applied to the connection object 70 by the removing portion 36 in the partially inserted state. The removing portion 36 at the front end of the contact piece 34 contacts the signal line 73 of the connection object 70. This allows the first contact 30 to apply a minimum pressure, which is needed to remove foreign matter adhering to the signal line 73 of the connection object 70, to the connection object 70. This reduces breakage of the connection object 70 during insertion of the connection object 70 into the insertion portion 23. The rounded apex part 36b of the removing portion 36 significantly increases the effect of reducing such breakage.

In contrast, the contact portion 35 located next to the elastic portion 33 in the first contact 30 can provide pressure that is necessary for the first contact 30 in the fully inserted state to press the connection object 70 from below. The connector 10 can hold the connection object 70 with such pressure applied from below by the first contact 30, pressure applied from above by the second contact 40a, and a reaction force applied by an upper face of the insertion portion 23 of the insulator 20. As described above, the connector 10 can stably hold the connection object 70 with sufficient holding power even in use in an environment with high vibration, for example, in electronic devices including industrial equipment and on-vehicle equipment. The rounded apex part 35b of the contact portion 35 reduces breakage of the connection object 70 in the fully inserted state.

The insertion portion 23 includes the inner face 23d, serving as a reference to position the end face 72 of the connection object 70 in the insertion direction in the fully inserted state. This facilitates positioning of the connection object 70 relative to the connector 10 in the front-rear direction. This improves case of operation in inserting the connection object 70 into the insertion portion 23.

The distance d1 is larger than the distance d2 in the insertion direction. This ensures that the foreign-matter-free face, from which foreign matter is removed by the removing portion 36, of the signal line 73 of the connection object 70 is brought into contact with the contact portion 35 of the first contact 30. This reduces corrosion that is caused by contact between the contact portion 35 and the signal line 73 with foreign matter and that results from the difference in ionization tendency therebetween. More specifically, foreign matter adheres to the removing portion 36 and separates from the signal line 73 of the connection object 70, resulting in reduction of the foreign matter between the signal line 73 and the contact portion 35. Therefore, the above-described corrosion can be reduced.

The locking protrusion 52 of the actuator 50 presses the connection object 70 toward the first contact 30 in the partially inserted state. Thus, even if contact pressure applied from the first contact 30 to the connection object 70 is insufficiently provided only by pressure applied from below by the first contact 30, the connection object 70 can be stably held with pressure applied from above by the actuator 50 in addition to the pressure applied from below. This further improves a foreign matter removal effect of the removing portion 36 of the first contact 30.

The locking protrusion 52 of the actuator 50 is located closer to the removing portion 36 than to the contact portion 35 of the first contact 30. This reduces an increase in insertion force of the connection object 70 relative to the connector 10. This improves the ease of operation in inserting the connection object 70 into the connector 10.

In the partially inserted state, the removing portion 36 of the first contact 30 and the top wall 21a of the insulator 20 hold the connection object 70 therebetween, thus allowing the removing portion 36 to stably exert the foreign matter removal effect. For example, if two contacts held the connection object therebetween, individual differences between the contacts might cause the contacts to have different spring forces or different performances of foreign matter removal. Similarly, in the fully inserted state, the contact portion 35 of the first contact 30 and the top wall 21a of the insulator 20 hold the connection object 70 therebetween, thus maintaining stable contact between the contact portion 35 and the signal line 73.

The top wall 21a of the insulator 20 is located between the actuator 50 and the contact and removing portions 35 and 36 of the first contact 30. Thus, the insulator 20 is aligned with the first contact 30 in the up-down direction in the partially inserted state and the open state, thus reducing exposure of the first contact 30. This can easily reduce a likelihood that foreign matter outside the connector 10 may enter the connector 10, especially the insertion portion 23 and the first-contact mounting groove 24 where the first contact 30 is located. This results in improved reliability of the connector 10 as a product. Combination of such a configuration and the removing portion 36 for removing foreign matter adhering to the signal line 73 of the connection object 70 sufficiently reduces entry of foreign matter into the connector 10.

It will be apparent to those skilled in the art that the present disclosure can be implemented in other specific forms in addition to the above-described embodiment without departing from the spirit or essential characteristics thereof. Therefore, the above description is illustrative and is not restrictive. The scope of the present disclosure is defined by the appended claims, rather than the foregoing description. Some variations that are within the range of equivalents of all variations are intended to be encompassed within the scope of the present disclosure.

For example, the shape, arrangement, orientation, number, and the like of the components described above are not limited to those illustrated in the above description and the figures. Any shape, arrangement, orientation, number, and the like of the components that realize the functions thereof may be used.

The above-described method of assembling the connector 10 is not limited to details in the above description. The connector 10 may be assembled in any manner that allows the functions to be achieved. For example, at least one selected from the group consisting of the first contact 30, the second contact 40a, the fitting 40b, and the pressing member 60 may be formed integrally with the insulator 20 by insert molding, rather than press fitting.

In the above-described embodiment, the mated portion includes the projection 57, and the mating portion includes the hole 27c. The configuration is not limited to this example. The mated portion and the mating portion may include any engagement structure that reduces bending of the actuator 50. For example, the mated portion may include the projection 57 projecting from the second outer surface 51b toward the mating portion. The mating portion may include a recess to receive the projection 57. For example, the mating portion may include a projection projecting from the restricting face 27b of the insulator 20 toward the mated portion. The mated portion may include a recess or hole to receive the projection.

In the above-described embodiment, the mated portion includes the sloped face 57a continuous with the second outer surface 51b and sloping therefrom at the projection 57. The configuration is not limited to this example. The mated portion may include, instead of the sloped face 57a, a flat face perpendicular to the second outer surface 51b and extending therefrom at the projection 57. In this case, such a flat face may face the open-position-side inner face S of the mating portion.

In the above-described embodiment, the adjacent portion R of the projection 57 adjacent to the second outer surface 51b on the open position side faces the edge C of the insulator 20 at the mating portion on the open position side. The configuration is not limited to this example. The adjacent portion R does not necessarily need to face the edge C of the insulator 20. The insulator 20 may include no edge C.

In the above-described embodiment, the insulator 20 includes the restricting face 27b, which contacts the second outer surface 51b when the actuator 50 is in the open position. The configuration is not limited to this example. The insulator 20 may include, instead of the restricting face 27b, any structure that reduces excessive opening of the actuator 50. For example, the insulator 20 may include a protrusion to contact the second outer surface 51b when the actuator 50 is in the open position.

In the above-described embodiment, the mated portion mates with the mating portion when the actuator 50 is in the open position, and is apart from the mating portion and does not mate with the mating portion when the actuator 50 is in the closed position. The configuration is not limited to this example. The mated portion may mate with the mating portion when the actuator 50 is in the closed position. The mated portion needs only to mate with the mating portion at least when the actuator 50 is in the open position. When the actuator 50 is in the closed position, the mated portion may mate with the mating portion or does not necessarily need to mate with the mating portion.

In the above-described embodiment, sets of the mated and mating portions are located at the positions corresponding to the opposite ends of the operating portion 55 in the longitudinal direction of the connector 10. The configuration is not limited to this example. A set of the mated and mating portions may be located at the position corresponding to either one of the opposite ends of the operating portion 55 in the longitudinal direction of the connector 10. A set of the mated and mating portions may be located between the opposite ends of the operating portion 55 in the longitudinal direction of the connector 10. At least one set of the mated and mating portions may be located at any position between the two mounting portions 53b. For example, only one mated portion may extend lengthwise in a central part of the second outer surface 51b of the base portion 51 in the left-right direction.

In the above-described embodiment, each mounting portion 53b allows the actuator 50 to be mounted on the insulator 20 in response to receiving an urging force applied from the open position side by the pressing member 60. The configuration is not limited to this example. The actuator 50 may be mounted directly on the insulator 20, instead of or in addition to such a configuration in which the actuator 50 is indirectly mounted on the insulator 20 with the pressing member 60. For example, the mounting portion 53b of the actuator 50 may be elastically deformable in the left-right direction. The mounting portion 53b may be mounted on the insulator 20 while being elastically deformed and engaged with a groove of the insulator 20 that has a width slightly smaller than the width of the mounting portion 53b in the left-right direction.

The connector 10 may include any structure that allows the actuator 50 to be directly mounted on the insulator 20 without the pressing member 60. For example, the connector 10 may include no pressing member 60 and be configured such that the actuator 50 is mounted on the insulator 20 only with engagement between the protrusion 54a of the actuator 50 and the recess 29a of the insulator 20.

In the above-described embodiment, insertion of the connection object 70 into the insertion portion 23 requires an insertion force that acts against the locking protrusion 52 of the actuator 50. The configuration is not limited to this example. The connector 10 may include a ZIF (zero insertion force) structure in which the connection object 70 can be inserted into the insertion portion 23 with an insertion force close to zero while being not in contact with the actuator 50.

In the above-described embodiment, the apex part 35b of the contact portion 35 has a rounded shape. The configuration is not limited to this example. The apex part 35b may have any shape. For example, the apex part 35b may have a sharp-edged shape. Similarly, in the above-described embodiment, the apex part 36b of the removing portion 36 has a rounded shape. The configuration is not limited to this example. The apex part 36b may have any shape. For example, the apex part 36b may have a sharp-edged shape.

In the above-described embodiment, the elastic portion 33 and the contact piece 34 of the first contact 30 are arranged below the insertion portion 23 and the connection object 70, and the contact piece 34 is inclined downward as the elastic portion 33 is elastically deformed downward. The configuration is not limited to this example. For example, the elastic portion 33 and the contact piece 34 of the first contact 30 may be arranged above the insertion portion 23 and the connection object 70. The contact piece 34 may be inclined upward as the elastic portion 33 is elastically deformed upward.

In the above-described embodiment, the contact piece 34 extends toward the insertion opening 23a of the insertion portion 23 while being angled relative to the elastic portion 33. The configuration is not limited to this example. The contact piece 34 may connect to the elastic portion 33 with any structure that achieves contact between the removing portion 36 and the signal line 73 in the partially inserted state, separation of the removing portion 36 from the signal line 73 in the fully inserted state, and contact between the contact portion 35 and the signal line 73 in the fully inserted state. For example, the contact piece 34 does not necessarily need to be at an obtuse angle to the front end of the elastic portion 33. The contact piece 34 does not necessarily need to be angled relative to the elastic portion 33. For example, the contact piece 34 may be part of the elastic portion 33.

In the above-described embodiment, the width of the removing portion 36 is larger than or equal to the width of the contact portion 35. The configuration is not limited to this example. The width of the removing portion 36 may be smaller than the width of the contact portion 35.

In the above-described embodiment, in the non-insertion state, the straight line connecting the apex part 35b of the contact portion 35 and the apex part 36b of the removing portion 36 extends substantially horizontally. The configuration is not limited to this example. The straight line connecting the apex part 35b of the contact portion 35 and the apex part 36b of the removing portion 36 does not necessarily need to extend substantially horizontally.

In the above-described embodiment, in the partially inserted state, the straight line connecting the apex part 35b of the contact portion 35 and the apex part 36b of the removing portion 36 is inclined obliquely downward. The configuration is not limited to this example. The straight line connecting the apex part 35b of the contact portion 35 and the apex part 36b of the removing portion 36 does not necessarily need to be inclined.

In the above-described embodiment, the removing portion 36, the contact portion 35, and the elastic portion 33 are arranged in that order from the insertion-opening-23a side. The configuration is not limited to this example. The first contact 30 may include any structure that achieves contact between the removing portion 36 and the signal line 73 in the partially inserted state, separation of the removing portion 36 from the signal line 73 in the fully inserted state, and contact between the contact portion 35 and the signal line 73 in the fully inserted state. For example, the elastic portion 33, the removing portion 36, and the contact portion 35 may be arranged in that order from the insertion-opening-23a side. For example, the removing portion 36, the elastic portion 33, and the contact portion 35 may be arranged in that order from the insertion-opening-23a side.

In the above-described embodiment, the insertion portion 23 includes the inner face 23d, serving as a reference to position the end face 72 of the connection object 70 in the insertion direction in the fully inserted state. The configuration is not limited to this example. The insertion portion 23 may include no inner face 23d. In this case, the insulator 20 may include any structure to position, for example, opposite ends of the connection object 70 in the left-right direction, in the insertion direction.

In the above-described embodiment, the distance d1 is larger than the distance d2 in the insertion direction. The configuration is not limited to this example. The distance d1 may be smaller than the distance d2 in the insertion direction.

In the above-described embodiment, the actuator 50 of the connector 10 can be operated by only one action of inserting the connection object 70. The configuration is not limited to this example. The connector 10 may need any direct operation on the actuator 50 that is performed by, for example, an operator or an assembly apparatus.

In the above-described embodiment, the width of the first-contact mounting groove 24 at the removing portion 36 and the width thereof at the contact portion 35 are equal to each other. The configuration is not limited to this example. For the width of the first-contact mounting groove 24 in the direction orthogonal to the direction in which the contact portion 35 protrudes from the contact piece 34 and orthogonal to the insertion direction in which the connection object 70 is inserted, the width thereof may be large at the removing portion 36, and may be small at the contact portion 35. Such a configuration facilitates removal of foreign matter adhering to the connection object 70 at the removing portion 36 and can reduce movement of foreign matter adhering to the connection object 70 to the contact portion 35 of the first contact 30.

The width of the first-contact mounting groove 24 in the direction orthogonal to the direction in which the contact portion 35 protrudes from the contact piece 34 and orthogonal to the insertion direction in which the connection object 70 is inserted may change in a stepwise manner in a region between the removing portion 36 and the contact portion 35. As described above, the width of the first-contact mounting groove 24 in the direction orthogonal to the direction in which the contact portion 35 protrudes from the contact piece 34 and orthogonal to the insertion direction, in which the connection object 70 is inserted, changes sharply in the region between the removing portion 36 and the contact portion 35. This significantly increases the above-described effect of reducing the movement of foreign matter to the contact portion 35 of the first contact 30.

The manner of change of the width of the first-contact mounting groove 24 in the direction orthogonal to the direction in which the contact portion 35 protrudes from the contact piece 34 and orthogonal to the insertion direction in which the connection object 70 is inserted is not limited to the stepwise manner. The width of the first-contact mounting groove 24 may change in any manner in the region between the removing portion 36 and the contact portion 35. For example, the width of the first-contact mounting groove 24 in the direction orthogonal to the direction in which the contact portion 35 protrudes from the contact piece 34 and orthogonal to the insertion direction in which the connection object 70 is inserted may continuously decrease in the region between the removing portion 36 and the contact portion 35.

In the above-described embodiment, the contact piece 34 includes protrusions only at the contact portion 35 and the removing portion 36. The configuration is not limited to this example. The contact piece 34 may include another protrusion that is located between the removing portion 36 and the contact portion 35 and protrudes in the same direction as that in which the removing portion 36 and the contact portion 35 protrude. In such a configuration, only the contact portion 35 contacts the signal line 73 of the connection object 70 in the fully inserted state. This configuration enables removal of foreign matter adhering to the connection object 70 at the removing portion 36 and can reduce the movement of foreign matter adhering to the connection object 70 to the contact portion 35 of the first contact 30.

The above-described connector 10 is mounted on an electronic device. Examples of the electronic device include any on-vehicle equipment including a camera, a radar, a dashboard camera, and an engine control unit. Examples of the electronic device include any on-vehicle equipment used in on-vehicle systems, such as a car navigation system, an advanced driver assistance system, and a security system. Examples of the electronic device further include any industrial equipment. Examples of the electronic device are not limited to those described above. Examples of the electronic device may include any information equipment, such as a personal computer, a smartphone, a copier, a printer, a facsimile, and a multifunctional machine. Examples of the electronic device may include any audio-visual equipment, such as a liquid crystal television set, a recorder, a camera, and a headphone.

Such an electronic device, serving as a product, has improved reliability due to the above-described advantages in that the connector 10 can maintain reliability even when reduced in profile.

The following concepts can be extracted from the present disclosure.
(1)

A connector into and from which a connection object is insertable and removable, the connector including:
an insulator including an insertion portion into which a connection object is to be inserted; and
an actuator rotatable relative to the insulator between a closed position in which the actuator is closed relative to the insulator and an open position in which the actuator is opened relative to the insulator,
the actuator including:
   two mounting portions respectively located on opposite ends of the actuator in a longitudinal direction of the connector, the two mounting portions allowing the actuator to be mounted on the insulator;
   an operating portion located between the two mounting portions on a first outer surface of the actuator that faces in an insertion and removal direction of the connection object relative to the connector, the operating portion being configured to be operated to open the actuator from the closed position to the open position; and
   a mated portion located between the two mounting portions on a second outer surface of the actuator that is opposite the first outer surface,
wherein the insulator includes a mating portion to mate, from an open-position side, with the mated portion at least when the actuator is in the open position.
(2)

The connector according to (1), wherein
the mated portion includes a projection projecting from the second outer surface toward the mating portion, and
the mating portion includes a recess or hole to receive the projection.
(3)

The connector according to (2), wherein
the mated portion includes a sloped face continuous with the second outer surface and sloping from the second outer surface at the projection, and
the sloped face faces an inner face of the mating portion that is located on the open-position side.
(4)

The connector according to (2) or (3), wherein the projection includes an adjacent portion adjacent to the second outer surface on the open-position side, and the adjacent portion faces an edge of the insulator that is located at the mating portion on the open-position side.
(5)

The connector according to any one of (2) to (4), wherein the insulator includes a restricting face to contact the second outer surface when the actuator is in the open position.
(6)

The connector according to any one of (1) to (5), wherein the mated portion mates with the mating portion when the actuator is in the open position, and is apart from the mating portion and does not mate with the mating portion when the actuator is in the closed position.
(7)

The connector according to (6), wherein the mated portion faces an inner face of the mating portion that is located on the open-position side in a direction orthogonal to the longitudinal direction and orthogonal to the insertion and removal direction when the actuator is in the open position, and does not face the inner face in the direction orthogonal to the longitudinal direction and orthogonal to the insertion and removal direction when the actuator is in the closed position.
(8)

The connector according to any one of (1) to (7), wherein a set of the mated portion and the mating portion is located at a position corresponding to at least one of opposite ends of the operating portion in the longitudinal direction.
(9)

The connector according to any one of (1) to (8), further including:
a pressing member configured to urge the actuator toward the closed position when the actuator is in the open position,
wherein each of the two mounting portions allows the actuator to be mounted on the insulator in response to receiving an urging force applied from the open-position side by the pressing member.
(10)

An electronic device including the connector according to any one of (1) to (9).

### REFERENCE SIGNS

10 connector
20 insulator
21 outer peripheral wall
21a top wall
21b bottom wall
21c side wall
22 rear wall
23 insertion portion
23a insertion opening
23b first angled face
23c second angled face
23d inner face
24 first-contact mounting groove
25 second-contact mounting groove
26 fitting mounting groove
27 mounting portion
27a recess
27b restricting face
27c hole (mating portion)
28 mounting groove
28a through-hole
29 receiving portion
29a recess
30 first contact
31 engaging portion
31a extending portion
32 installation portion
33 elastic portion
34 contact piece
35 contact portion
35a first sloped face
35b apex part
35c second sloped face
36 removing portion
36a first sloped face
36b apex part
36c second sloped face
40a second contact
40b fitting
41a installation portion
41b installation portion
42a base portion
42b base portion
43a engaging portion
43b engaging portion
44a contact piece
50 actuator
51 base portion
51a first outer surface
51b second outer surface
52 locking protrusion
52a sloped face
53a hollow
53b mounting portion
54 pivot
54a protrusion
55 operating portion
56 raised portion
57 projection (mated portion)
57a sloped face
60 pressing member
61 engaging portion
62 installation portion
63 contact portion
70 connection object
71 end portion
72 end face
73 signal line
74 outer cover
75 retainer
76 lock recess
77 guide
CB circuit board
C edge
R adjacent portion
S inner face
d1 distance
d2 distance
θ1 first angle
θ2 second angle

1. A connector into and from which a connection object is insertable and removable, the connector comprising:
an insulator comprising an insertion portion into which a connection object is to be inserted; and
an actuator rotatable relative to the insulator between a closed position in which the actuator is closed relative to the insulator and an open position in which the actuator is opened relative to the insulator,
the actuator comprising:
two mounting portions respectively located on opposite ends of the actuator in a longitudinal direction of the connector, the two mounting portions allowing the actuator to be mounted on the insulator;
an operating portion located between the two mounting portions on a first outer surface of the actuator that faces in an insertion and removal direction of the connection object relative to the connector, the operating portion being configured to be operated to open the actuator from the closed position to the open position; and
a mated portion located between the two mounting portions on a second outer surface of the actuator that is opposite the first outer surface,
wherein the insulator comprises a mating portion to mate, from an open-position side, with the mated portion at least when the actuator is in the open position.

2. The connector according to claim 1, wherein
the mated portion includes a projection projecting from the second outer surface toward the mating portion, and
the mating portion includes a recess or hole to receive the projection.

3. The connector according to claim 2, wherein
the mated portion includes a sloped face continuous with the second outer surface and sloping from the second outer surface at the projection, and
the sloped face faces an inner face of the mating portion that is located on the open-position side.

4. The connector according to claim 2, wherein the projection includes an adjacent portion adjacent to the second outer surface on the open-position side, and the adjacent portion faces an edge of the insulator that is located at the mating portion on the open-position side.

5. The connector according to claim 2, wherein the insulator comprises a restricting face to contact the second outer surface when the actuator is in the open position.

6. The connector according to claim 1, wherein the mated portion mates with the mating portion when the actuator is in the open position, and is apart from the mating portion and does not mate with the mating portion when the actuator is in the closed position.

7. The connector according to claim 6, wherein the mated portion faces an inner face of the mating portion that is located on the open-position side in a direction orthogonal to the longitudinal direction and orthogonal to the insertion and removal direction when the actuator is in the open position, and does not face the inner face in the direction orthogonal to the longitudinal direction and orthogonal to the insertion and removal direction when the actuator is in the closed position.

8. The connector according to claim 1, wherein a set of the mated portion and the mating portion is located at a position corresponding to at least one of opposite ends of the operating portion in the longitudinal direction.

9. The connector according to claim 1, further comprising:
a pressing member configured to urge the actuator toward the closed position when the actuator is in the open position,
wherein each of the two mounting portions allows the actuator to be mounted on the insulator in response to receiving an urging force applied from the open-position side by the pressing member.

10. An electronic device comprising the connector according to claim 1.
